(19) United States
(12) Patent Application Publication
(10) Pub. No.: US 2003/0043582 A1
(43) Pub. Date: Mar. 6, 2003

(54) Delivery mechanism for a laser diode array

(75) Inventors: Kin Foong Chan, Plano, TX (US); Wenhui Mei, Plano, TX (US); Takashi Kanatake, Dallas, TX (US); Akira Ishikawa, Royse City, TX (US); Toshio Matsushita, Anan-shi (JP)

Correspondence Address: HAYNES AND BOONE, LLP, 901 MAIN STREET, SUITE 3100, DALLAS, TX, 75202, US

(73) Assignee: Ball Semiconductor, Inc., Allen, TX (US)

(21) Appl. No.: 09/942,142

(22) Filed: Aug. 29, 2001

(51) Int. Cl. F21V 7/00; F21K 2/00

(52) U.S. Cl. 362/259; 362/240; 362/800; 362/241; 362/247

(57) ABSTRACT

A laser diode array light source includes a plurality of semiconductor diodes attached to a first substrate, with each diode having an aperture for emitting an output of light positioned on a side of the diode, the side being generally perpendicular to the first substrate. A second substrate is positioned adjacent to the first substrate and includes a plurality of reflective surfaces for redirecting each of the outputs of light. In this way, the light from the plurality of diodes can be commonly directed to provide a directional light source.

### BACKGROUND OF THE INVENTION

This disclosure relates generally to semiconductor diodes, such as can be used as incoherent light sources in display systems and/or photolithography exposure systems.

In conventional display and photolithography exposure systems, an image source is required for exposing an image onto a subject. With photolithography systems, the subject may be a photo resist coated semiconductor wafer for making integrated circuits, a metal substrate for making etched lead frames, or a conductive plate for making printed circuit boards. With display systems, the subject may be a display screen, such as is used by a projector. For the sake of the present discussion, display systems and exposure systems will be collectively discussed as “imaging systems,” unless otherwise noted. Other uses of imaging systems, in general, include biomedical and chemical applications such as curing, sterilization, gene therapy, gene array fabrication, bio-stimulation, and so forth.

U.S. patent application Ser. No. 60/274,371 describes methods and apparatuses for efficiently combining the light power of multiple laser diodes into a high power source, and eliminating the coherence noise of the laser diodes for uniform illumination, such as can be used in imaging systems.

It is desired to improve the cost and efficiency of laser diodes, such as those used in the laser diode array described in the above-referenced patent application.

### SUMMARY

The present invention provides a new and unique light source that utilizes a laser diode array. In one embodiment, the light source includes a plurality of semiconductor diodes attached to a first substrate, with each diode having an aperture for emitting an output of light positioned on a side of the diode, the side being generally perpendicular to the first substrate. A second substrate is positioned adjacent to the first substrate and includes a plurality of reflective surfaces for redirecting each of the outputs of light. In this way, the light from the plurality of diodes can be commonly directed to provide a directional light source.

In another embodiment, the light source includes a plurality of diode modules. Each diode module includes at least one semiconductor diode and a substrate for positioning the semiconductor diode in a predetermined position. The substrate includes an inside surface coupled with the at least one semiconductor, at least one side surface having a first connecting means, and an interior body having a plurality of conduits operable to receive an aqueous fluid. In this way, at least two of the plurality of diode modules can be selectively coupled by way of the first connecting means so that at least two semiconductor diodes, one from each diode module, are spaced in close proximity to each other and are concentrically located in the light source.

In another embodiment, the light source includes a plurality of semiconductor diodes operable to emit light on a predetermined side, the semiconductor diodes being spaced and opposing each other such that the light emitted from all of the diodes are in a uniform pattern on a single focal plane. The light source also includes a plurality of support substrates, each support substrate having one or more conduits operable to cool the plurality of semiconductor diodes, and each support substrate further having a module keylock and a peripheral keylock for interlocking the plurality of support substrates to form a unified modular structure such that the plurality of semiconductor diodes are concentrically located in the light source. A lens system is also provided to focus the emitted light of the plurality of semiconductor diodes to form a single collimated beam of light.

In another embodiment, the light source includes at least four semiconductor diodes arranged adjacent to each other in pairs and positioned such that the light emitted by each of the plurality of semiconductor diodes is emitted in one predetermined direction. The light source also includes a substrate frame coupled with at least one semiconductor diode of each pair, the substrate frame including a plurality of conduits operable to receive an aqueous fluid. In some embodiments, the plurality of conduits include a cooling fluid inlet and a cooling fluid outlet. The pairs of semiconductor diodes are spaced on the substrate frame such that light emitted by the at least one pair of semiconductor diodes forms a uniform pattern on a single focal plane.

These and other embodiments discussed in the present disclosure, and additional embodiments inherently disclosed, improve the cost and efficiency of laser diodes and provide a new and unique light source that can be used in otherwise conventional imaging systems.

### BRIEF DESCRIPTION OF THE DRAWINGS

FIG. 1 illustrates one embodiment of a light source including a single side emitting diode paired with a reflective surface.

FIG. 2 illustrates another embodiment of a light source including a general alignment of two substrates with the lower substrate including an array of side emitting diodes and the upper substrate including an array of reflective surfaces.

FIG. 3 illustrates the cross section of one side emitting diode, a portion of lower substrate, and a portion of the upper substrate, all of FIG. 2.

FIGS. 4, 4a, and 4b illustrate the light source of FIG. 2 having an array of micro lenses incorporated into an upper substrate having an array of reflective surfaces.

FIG. 5 illustrates a symmetrical array of light beams generated by the light source of FIG. 2.

FIG. 6 illustrates a cross-section of another embodiment of a light source using side emitting diodes.

FIG. 7 illustrates another embodiment using the light source of FIG. 6.

FIG. 8 illustrates a cross-section of another embodiment of a light source using a stacked array of semiconductor diodes.

FIG. 9 illustrates another embodiment using the light source of FIG. 8.

FIG. 10 illustrates a light source according to another embodiment of the present invention.

FIGS. 11-12 illustrate yet another light source according to another embodiment of the present invention.

### DETAILED DESCRIPTION

The present disclosure relates to light emitting devices, such as can be used in any type of imaging system. Specific examples of substrates, layer configuration, materials, wavelengths, and other arrangements are described below to simplify the present disclosure. These are, of course, merely examples and are not intended to limit the invention from that described in the claims.

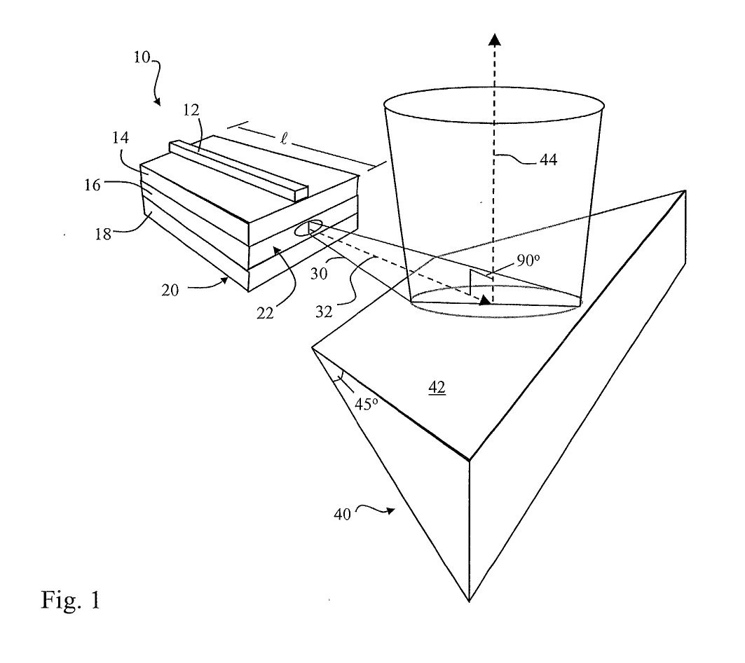

Referring now to FIG. 1 of the drawings, the reference numeral 10 refers, in general to a side emitting multi-mode laser diode. The diode 10 includes a wave guide 12, which also serves as a first electrode, a first P-layer 14, an active N-layer 16, a second P-layer 18, and a second electrode 20. It is understood that semiconductor diodes are well known in the art, and that various combinations and compositions of layers, wave guides, and electrodes can be use to accommodate different design choices.

The diode 10 has a side 22 from which it produces a light output 30 in a direction 32. The light output 30 can have a total output power greater than 4 Watts if the light has an ultraviolet wavelength, and greater than 100 Watts if the light has a visible or infrared wavelength. In the present embodiment, a length l of the waveguide 12 determines the wavelength.

The light output 30 is directed towards a device 40 with a reflective surface 42. The reflective surface is situated at a 45° angle with the direction 32. As a result, the light output 30 is directed in a perpendicular direction 44.

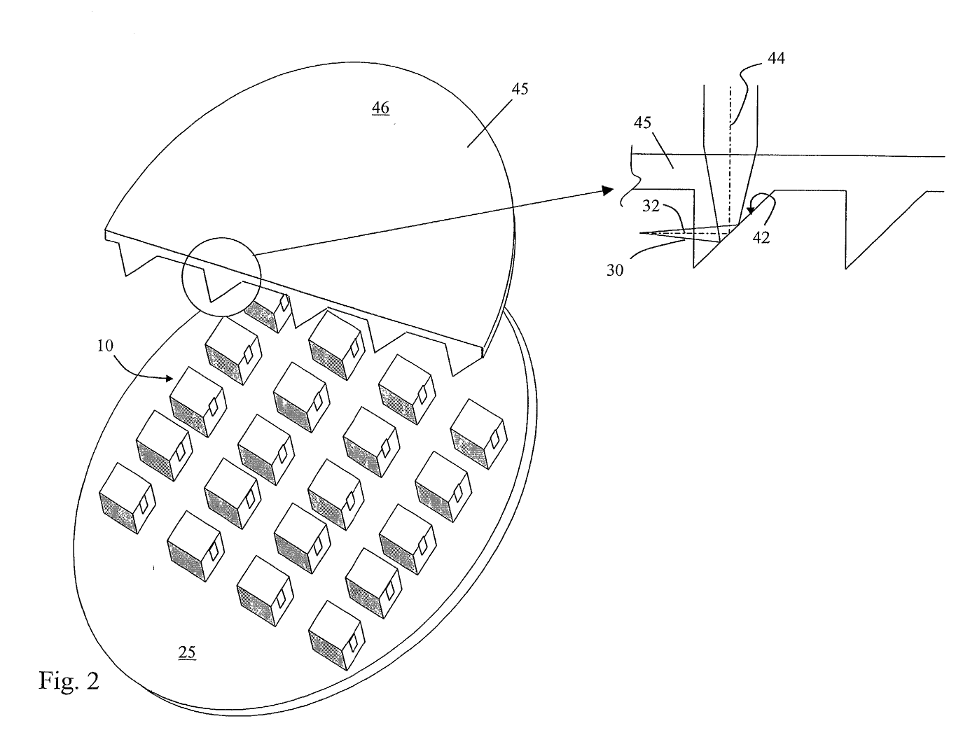

Referring now to FIG. 2, an array of two or more diodes 10 is attached to a first substrate 25. An array of reflective surfaces 42 is incorporated within a second substrate 45. The reflective surfaces 42 may be either attached to the surface of the second substrate 45 or may be machined from the substrate 45. As seen in the Figure, the first substrate 25 is positioned “below” the second substrate 45. The diodes 10 are positioned “even” with a lower portion 45l of the second substrate 45, and “below” an upper portion 45u. The lower portion 45l appears as a finger that extends down from the upper portion 45u of the second substrate 45. In some embodiments, the lower portion 45l may be a single, sold row that extends down from the upper portion 45u of the second substrate 45, corresponding to an entire row of diodes 10 (as illustrated in FIG. 2). In other embodiments, the lower portions 45l appear as individual “fingers” that extend down from the upper portion 45u of the second substrate 45 and that extend and are positioned to the side of each diode 10. The lower portion 45l positions the reflective surface 42 so that the light 30 that is emitted from the side 22 of the diode 10 impacts the reflective surface. The reflected light may then be directed through the upper surface 45u of the second substrate 45.

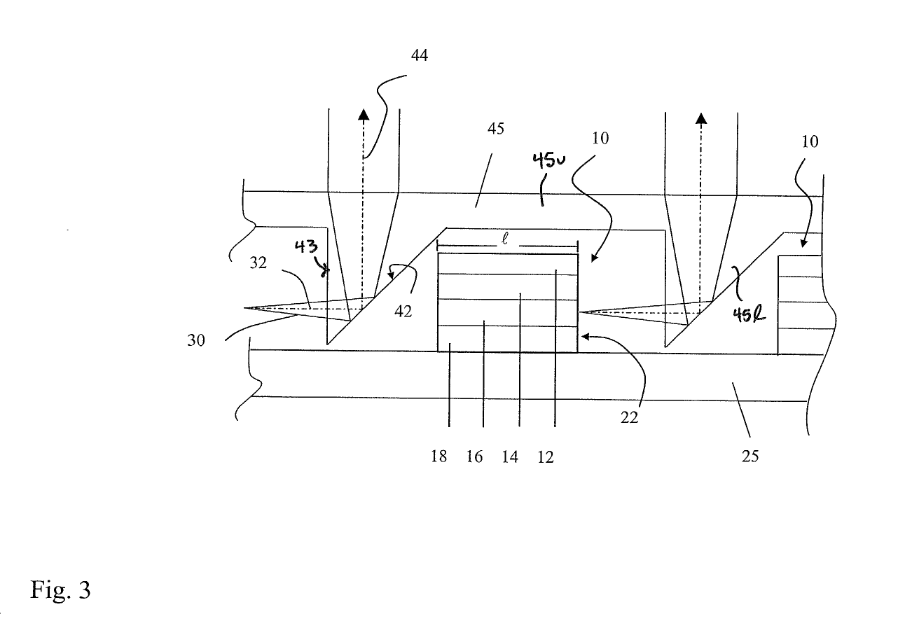

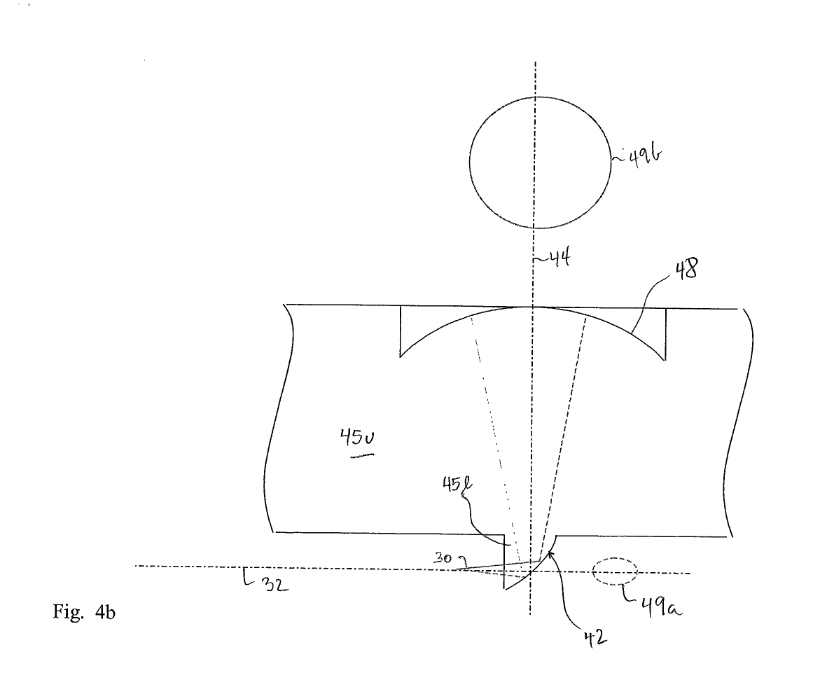

Referring now to FIGS. 3 and 5, a cross section of the substrates 45 and 25 illustrates the general positioning of the diodes 10 relative to the reflective surfaces 42. In this embodiment, the second substrate 45 is a monolithic, transparent substrate. The reflective surfaces 42 have been created by polishing only the portion of the substrate that is incident to the light 30. Since all of the reflective surfaces 42, in the present embodiments, are in parallel planes, a polishing process can simultaneously polish all of the reflective surfaces in a particular plane. In some embodiments, a anti-reflective coating 43 may also be applied to the lower portion 45l where the light 30 first contacts the substrate 45.

Each diode 10 is positioned so that the light emitted from the side 22 flows in a direction 32 which is generally parallel to the surface of substrate 25. The light enters the lower portion of the second substrate 45 and impacts the reflective surface 42, which is positioned at approximately 45° relative to the direction of the light 32. The light 30 is then reflected in a direction 44 through the upper portion of the substrate 45. The direction 44 is generally perpendicular to the direction 32.

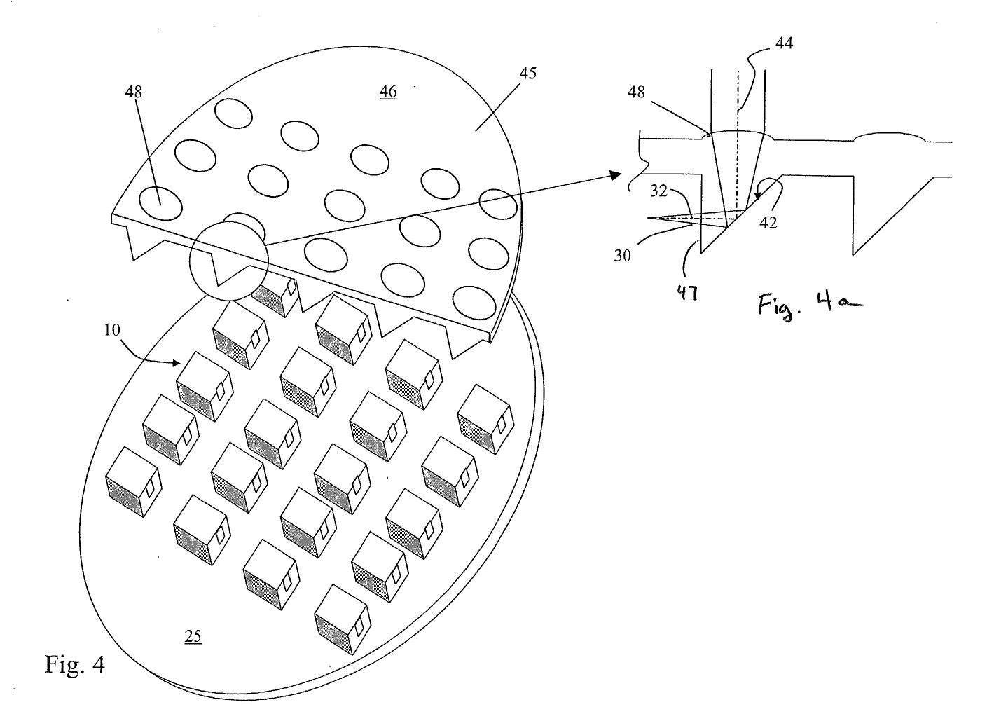

Referring now to FIG. 4, in some embodiments, the upper portion of the second substrate 45 includes an array of micro lenses 48. The micro lenses 48 may be attached to or machined from the surface 46 of substrate 45. Referring also to FIG. 4a, in some embodiments, the microlenses 48 are part of the same monolithic structure as the second substrate 45, but in other embodiments, they may be separately manufactured and positioned. In the present embodiment, each micro lens 48 corresponds to a diode 10 on the substrate 25. Each stream of reflected light is focused by a micro lens to produce a beam of collimated light.

Referring to FIGS. 4 and 4b, in some embodiments, the reflective surface 42 of the lower portion 45l appears is curved. This is because the light output 30 from some side-emitting laser diodes produces an oval shaped pattern, illustrated in phantom by outline 49a. The curved reflective surface 42 can compensate for the oval shaped pattern to produce a relatively circular light output 49b.

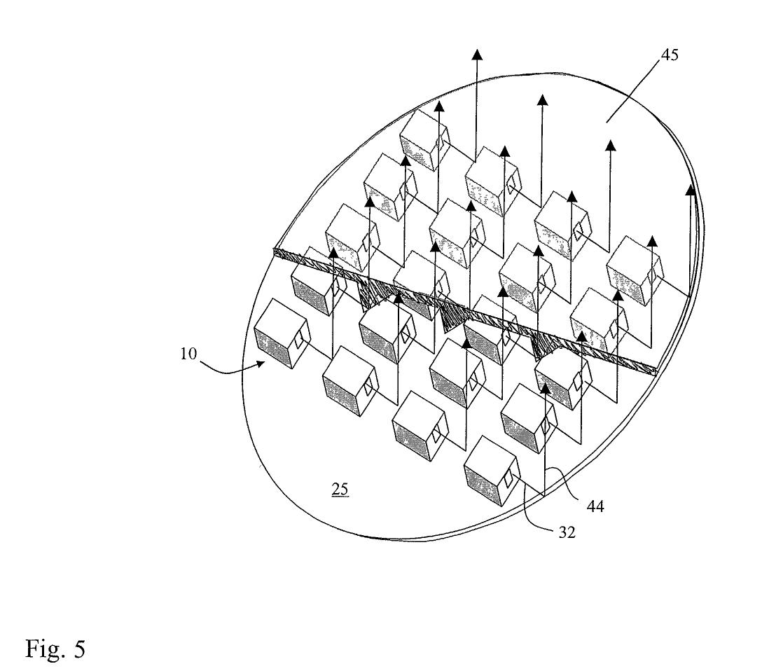

Referring now to FIG. 6, another embodiment of a light source is designated generally with the reference numeral 50. The light source 50 uses a plurality of side emitting multi-mode semiconductor laser diodes 10 to form a plurality of diode modules 52. Each diode module 52 includes a substrate 54 for coupling to an associated diode 10. The substrate 54 has an inside surface 56, a plurality of side surfaces 58, and an interior body 61. The inside surface 56 is coupled with the associated semiconductor diode 10. Each side surface 58 includes a first connecting means 64 to interlock a plurality of diode modules together. The interior body 61 of the diode modules 52 includes a plurality of conduits 65, 66 operable to receive and transport an aqueous fluid. The aqueous fluid may include water, coolant, and any other such aqueous substance suitable for purposes of cooling.

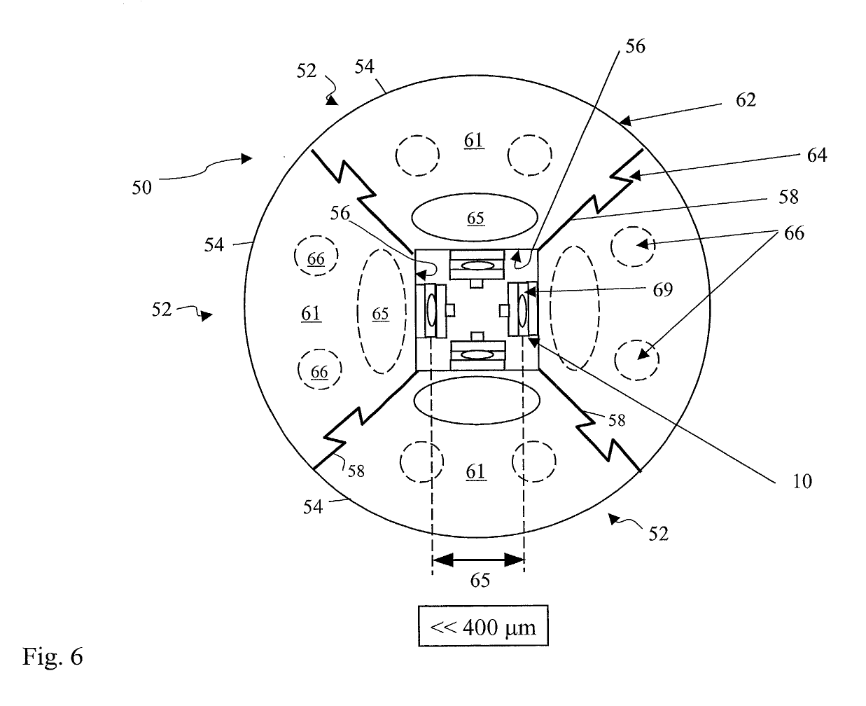

In one embodiment, each substrate 54 includes a single, relatively large cooling fluid inlet 65 and two, relatively small, cooling fluid outlets 66. The inlet 63 and outlets 66 are connected through a plenum 67, which is illustrated in FIG. 7. In this way, an aqueous fluid 68 (FIG. 7) may flow from the cooling fluid inlet 63 and to the cooling fluid outlet 63 to cycle the aqueous fluid through the diode module. In the present embodiment, the cooling fluid inlet 65 is located in close proximity to the inside surface 56 and the semiconductor diodes 10 to better perform the cooling function.

In one embodiment, four diode modules 52 are positioned and secured so that their associated four semiconductor diodes 10 are located concentrically in the light source 50 (as shown in FIG. 6). In a more specific embodiment, the diodes 10 are positioned so that an active region 69 of opposing semiconductor diodes are spaced a width of 400 micro meters or greater. This width accommodates heat convection/conduction while still keeping the diodes 10 in close proximity to form a single collimated beam of light (discussed in greater detail below). This embodiment further shows the first connecting means 64 being a module keylock operable to interlock adjacent diode modules.

The keylock 64 allows the modules 52 to be slid into place, so that the opposing surfaces 58 of adjacent substrates 54 frictionally engage each other and are further secured by the keylock. It is understood that the diode modules 52 may be of different shapes and sizes and the module keylock operates to interlock the adjoining diode modules so that a uniform modular structure is produced. As a result, the plurality of diode modules include a cross section surface so that each emitted light of the semiconductor diodes is focused in a uniform pattern on a single focal plane, parallel to the cross section surface.

Referring now to FIG. 7, in some embodiments, each substrate 54 of the plurality of diode modules 52 includes an outer surface 70 and a second connecting means 71. In one embodiment, the second connecting means 71 is a peripheral keylock operable to selectively secure adjacent substrates on the outer surface. The peripheral keylock 71 is also operable to align the light source. A combination of the keylocks 71 and 64 (FIG. 6) allows the modules 52 to be slid into a predetermined state so that the diodes 10 are all positioned and secured in a single projecting plane.

In some embodiments, the light source 50 is positioned and aligned with a micro lens 76a so that the micro lens is parallel with the projecting plane of the diodes 10. The micro lens 76a receives the emitted light 72 from the light source 50 and focuses the light into a single collimated beam of light 74. In some embodiments, the micro lens 76a is coupled with at least one aspherical coupling lens 76b. FIG. 7 also shows a light delivery device 78 operable to propagate the single collimated beam of light 74. The light delivery device 78 may be an optical fiber or any other suitable device for propagation and delivery of the single collimated beam of light 74. In some of the present embodiments, the light produced by all four diodes can be provided to a single fiber 78.

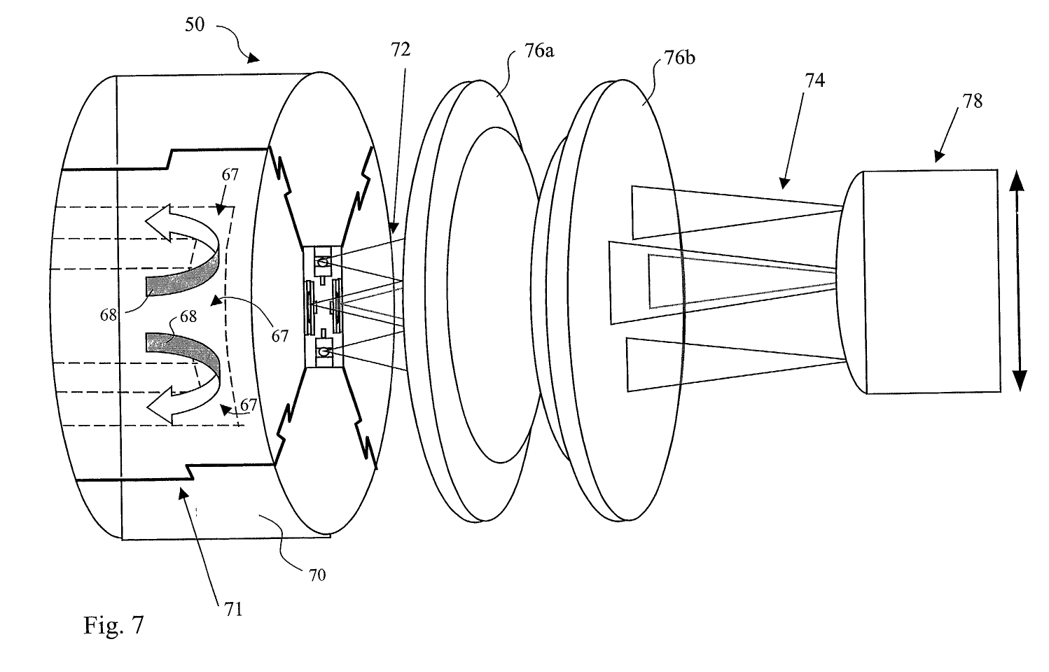

Referring now to FIG. 8, in yet another embodiment, a light source 80 includes a plurality of side emitting semiconductor laser diodes 10 and at least one substrate frame 82. The frame 82 is operable to couple with the plurality of semiconductor diodes 10 and includes a plurality of conduits 84, 86, for receiving an aqueous fluid. In one embodiment, the larger conduits 84 operate as cooling fluid inlets and the smaller conduits 86 operate as cooling fluid outlets.

In some embodiments, the conduits 84, 86 alternate so that a cooling fluid inlet 84 is at a relatively close distance to a closest diode 10, and the cooling fluid outlets 86 are a relatively far distance from the same diode. This arrangement creates an alternating and symmetrical pattern on the substrate frame to position the diodes 10 closer to the cooling fluid inlets 84. Although not shown, a plenum may allow the aqueous fluid to flow from one or more inlets 84 to one or more outlets 86, such as is shown with reference to FIG. 7.

In the present embodiment, the semiconductor diodes 10 are linearly spaced and located on the substrate frame 82 so that the at least one pair of semiconductor diodes 10 emit light in a uniform pattern on a single focal plane. The semiconductor diodes 10 forming the pair are arranged on the substrate frame so that the semiconductor diodes are contiguous. The configuration is a “butt-to-butt” configuration where each diode of the pair shares its waveguide 12 (FIG. 1) with the opposite diode. The butt-to-butt laser diodes reduce the number of channels for the stacked diode array of the light source 80. Reducing the channel number allows lower costs in delivering the laser light because the number of terminations, coupling lenses, and fibers are accordingly reduced. Also, the present arrangement provides a less complicated electrical wiring configuration.

Further, by having at least two substrate frames 82 connecting directly to opposite diodes in the butt-to-butt configuration, the multiple diode pairs form a “stacked” array. FIG. 8 shows one of such stacked arrays where the number of rows of semiconductor diodes, number of pairs of semiconductor diodes in a row, and number of substrate frames vary depending on the application. In some embodiments, the waveguides/electrodes 12 (FIG. 1) of each diode in a common row can be commonly connected by a conducting member 88. Many of these pairs of semiconductor diodes may then be arranged on additional substrate frames 82 spaced equally in relation to each other to form several rows of semiconductor diode pairs.

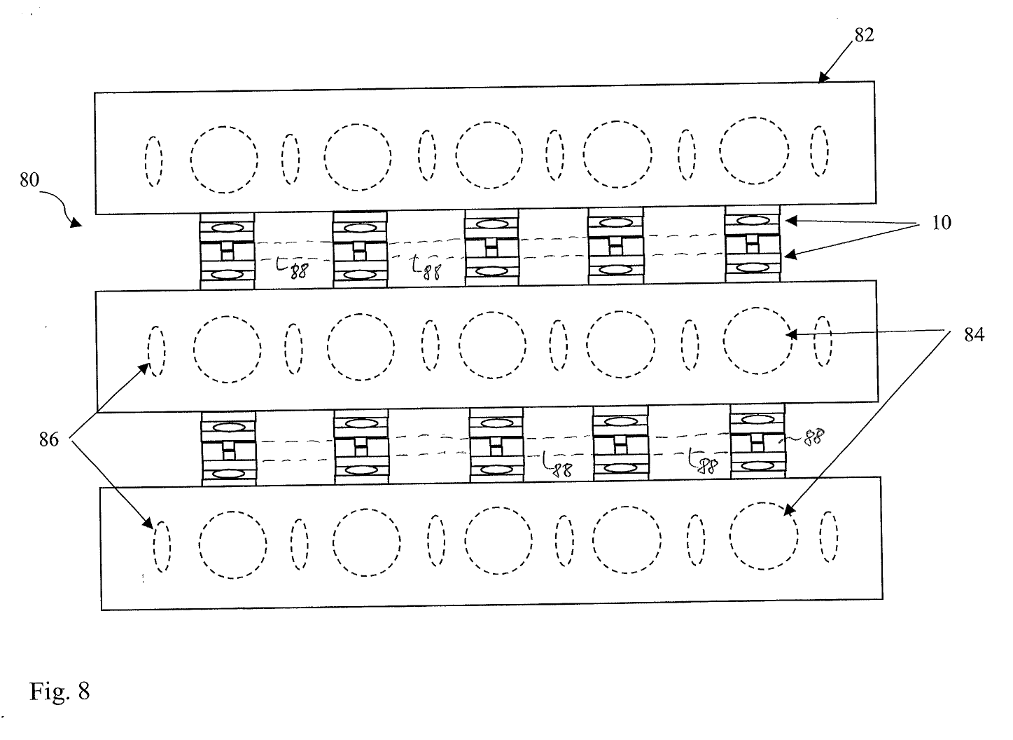

Referring now to FIG. 9, in some embodiments, the light source 80 may be positioned in conjunction with a plurality of micro lenses 90a and/or coupling lens 90b, one for each diode pair. The stacked array of semiconductor diodes emits a uniform pattern of light in a predetermined direction or side. In particular all of the semiconductor diodes forming the array are placed with their active regions pointing in the same parallel direction, and therefore emitting light on a single focal plane as shown with the emitted light 92. The emitted light 92 is received by the lenses 90a, 90b, which focus the light so that a collimated light 94 is produced. FIG. 9 shows a single beam of collimated light 94 for each pair of semiconductor diodes. Each single beam of collimated light 74 is further received by a light delivery device 78 which is operable to deliver or propagate the light according to the application. In the application shown, a coupling of 2 to 1 is accomplished by using one light delivery device for each semiconductor diode 10. The light delivery device 78 may be an optical fiber or any other suitable device for propagating or delivering light from two butt-to-butt diodes.

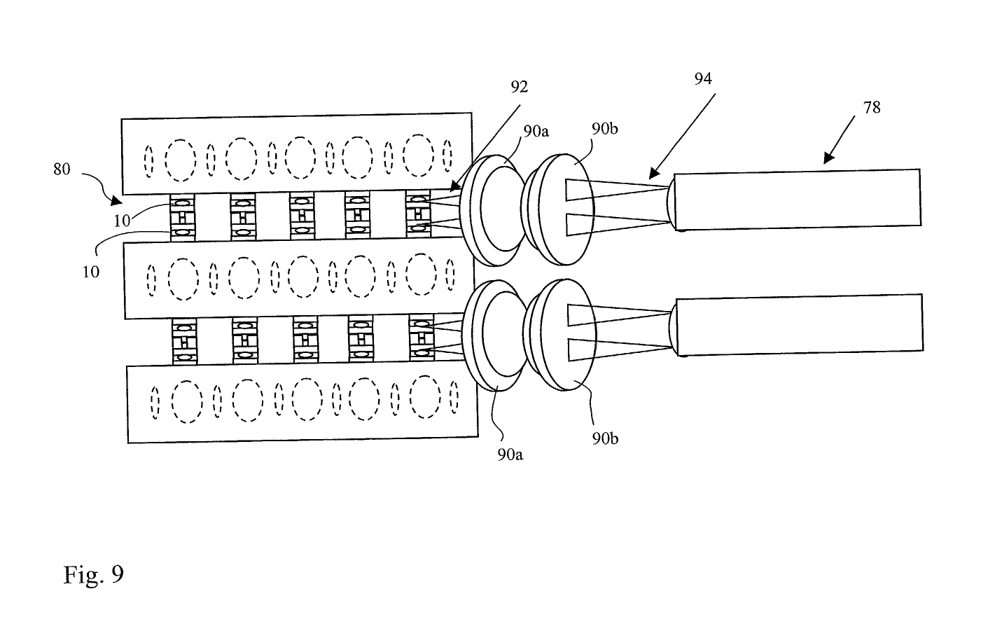

Referring now to FIG. 10, in another embodiment, a light source 100 can be produced from a plurality of side-emitting diodes 10 placed on a sapphire circuit substrate 102. In this embodiment, the diodes 10 have a laser tip 104 on sapphire. The diodes 10 are connected to electrodes 106 on the substrate 104 either directly, or by a bonding wire 108. The diodes 10 and substrate 102 are grouped into assemblies 110, several of such assemblies being further grouped to form a two-dimensional laser diode array.

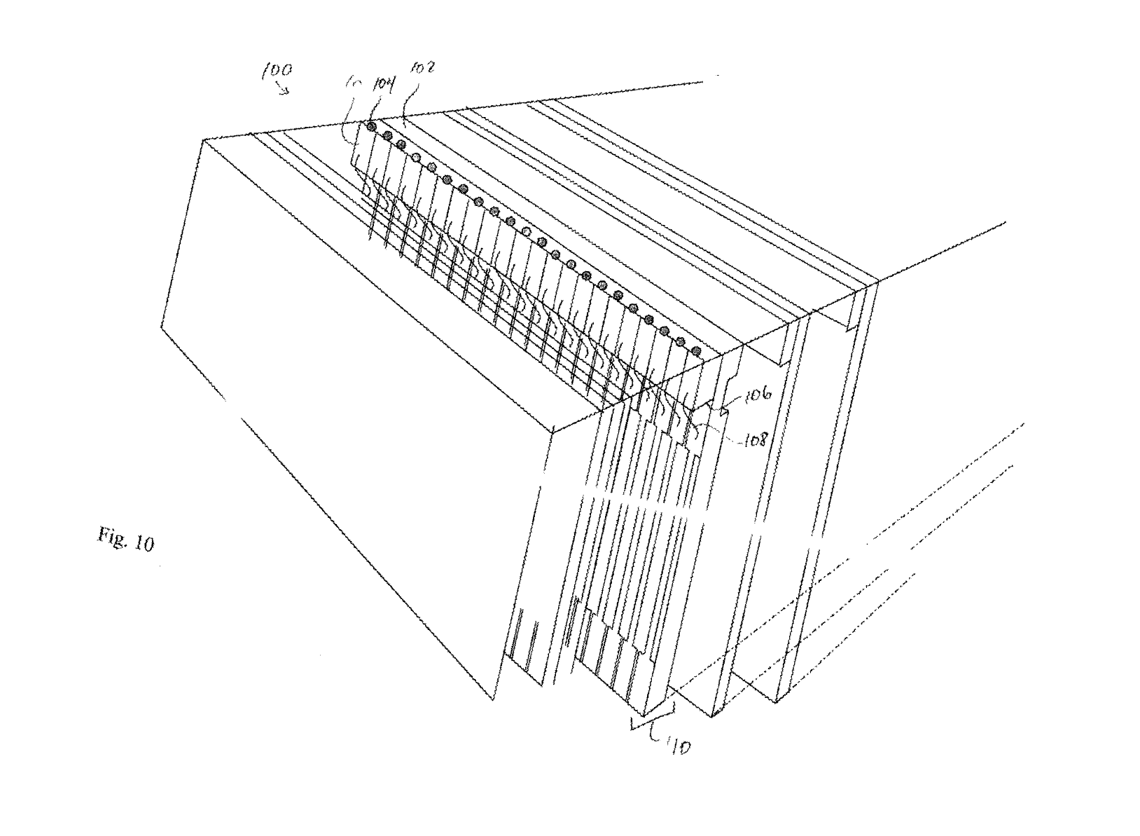

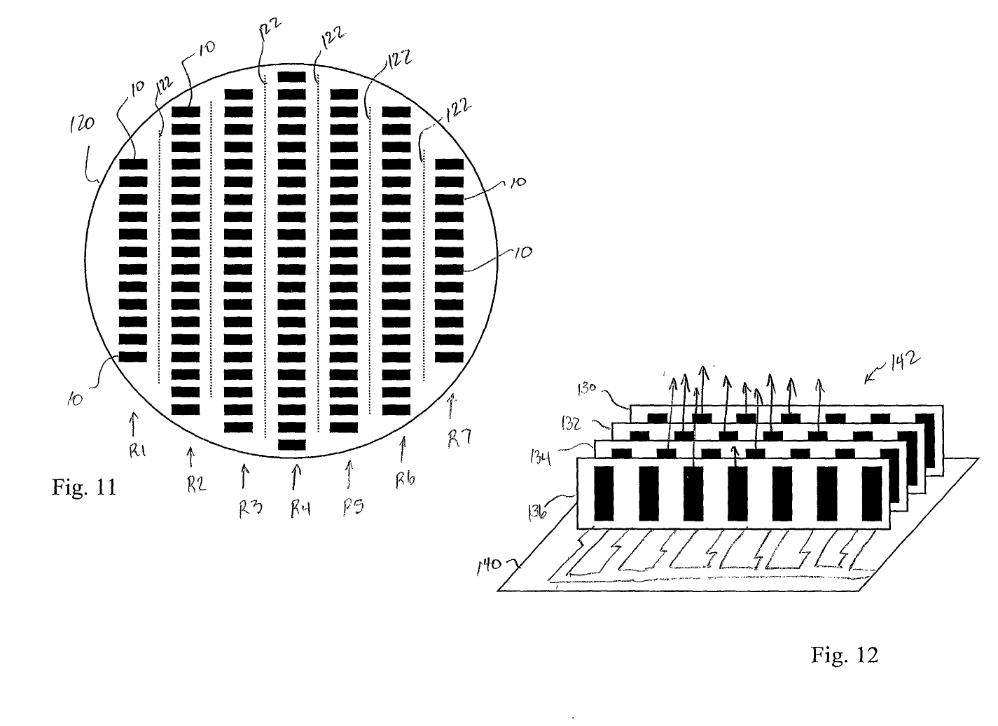

Referring now to FIGS. 11 and 12, in yet another embodiment, a wafer 120 having several rows R1-R7 of side-emitting diodes 10 can be sawed, as shown by the dotted lines 122. The rows R1, R2, R3, R4 etc. are then separated from each other, with the corresponding diodes 10 still attached to the sawed portion of the wafer substrate, collectively designated as assemblies 130, 132, 134, 136, etc. Although not shown, the assemblies may be further sawed to have a uniform number of diodes per row, as illustrated in FIG. 12. All of the present construction can use conventional micro-electrical-mechanical (MEMs) technology.

Referring specifically to FIG. 12, each assembly 130-136 of diodes is then stacked in a parallel arrangement with each other and connected to a printed circuit board 140. Once the proper electrical connections are made through the printed circuit board 140, a uniformly directed light distribution 142 may be produced.

While the invention has been particularly shown and described with reference to the preferred embodiment thereof, it will be understood by those skilled in the art that various changes in form and detail may be made therein without departing form the spirit and scope of the invention. Therefore, the claims should be interpreted in a broad manner, consistent with the present invention.

What is claimed is:

1. A light source comprising:
a plurality of semiconductor diodes attached to a first substrate, each diode having an aperture for emitting an output of light positioned on a side of the diode that is generally perpendicular to the first substrate;
a second substrate positioned adjacent to the first substrate and including a plurality of reflective surfaces for redirecting each of the outputs of light.

2. The light source of claim 1 wherein the second substrate further includes a plurality of micro lens, one for each of the plurality of semiconductor diodes, for individually focusing the reflected outputs of light into a single collimated light.

3. The light source of claim 1 wherein the first substrate is a semiconductor wafer upon which the diodes were manufactured.

4. The light source of claim 1 wherein the second substrate is a monolithic, substantially transparent structure including a lower portion and an upper portion, the lower portion including a polished area which provides the plurality of reflective surfaces, the lower portion extending towards the side of each of the plurality of diodes, and wherein there is an equal number of reflective surfaces and diodes.

5. A light source comprising a plurality of diode modules, each diode module further comprising:
at least one semiconductor diode; and
a substrate for positioning the semiconductor diode in a predetermined position, the substrate comprising an inside surface coupled with the at least one semiconductor, at least one side surface having a first connecting means, and an interior body having a plurality of conduits operable to receive an aqueous fluid;
wherein at least two of the plurality of diode modules are selectively coupled by way of the first connecting means so that at least two semiconductor diodes, one from each diode module, are spaced in close proximity to each other and are concentrically located in the light source.

6. The light source of claim 5, wherein the plurality of conduits of each diode module include further comprises at least one cooling fluid inlet and at least one cooling fluid outlet and where the aqueous fluid further comprises a cooling fluid for flowing from the at least one cooling fluid inlet to the at least one cooling fluid outlet.

7. The light source of claim 5, wherein the first connecting means comprises a module keylock operable to interlock adjacent diode modules.

8. The light source of claim 5, wherein each semiconductor diode has an active region operable to emit light and where the active regions of any two semiconductor diodes are spaced a width greater than 400 micro meters.

9. The light source of claim 5, wherein the positioning substrate of at least one diode module further comprises an outer surface and a second connecting means operable to interlock adjacent diode modules on the outer surface.

10. The light source of claim 5, further comprising a micro lens operable to focus the emitted light of the plurality of diode modules.

11. The light source of claim 5, further comprising at least one aspherical coupling lens positioned for forming the light from each diode module into a single collimated beam of light.

12. The light source of claim 11, further comprising a single optic fiber operable to collectively propagate the light from each diode module.

13. A light source comprising:
a plurality of semiconductor diodes operable to emit light on a predetermined side, wherein the semiconductor diodes are spaced and opposing each other such that the light is emitted in a uniform pattern on a single focal plane;
a plurality of support substrates, each support substrate having one or more conduits operable to cool the plurality of semiconductor diodes, and each support substrate further having a module keylock and a peripheral keylock for interlocking the plurality of support substrates to form a unified modular structure such that the plurality of semiconductor diodes are concentrically located in the light source; and
a lens system operable to focus the emitted light of the plurality of semiconductor diodes to form a single collimated beam of light.

14. A light source comprising:
at least four semiconductor diodes arranged adjacent to each other in pairs and positioned such that the light emitted by each of the plurality of semiconductor diodes is emitted in one predetermined direction; and
a first substrate frame coupled with at least one semiconductor diode of each pair, the first substrate frame including a plurality of conduits operable to receive an aqueous fluid, where the plurality of conduits further comprises a cooling fluid inlet and a cooling fluid outlet;
wherein the pairs of semiconductor diodes are spaced on the first substrate frame such that light emitted by the at least one pair of semiconductor diodes forms a uniform pattern on a single focal plane.

15. The light source of claim 14, wherein each semiconductor diode coupled to the first substrate frame includes a first electrode and a second electrode, where the second electrode is adjacent to the first substrate frame and the first electrode is contiguous to an electrode of the other semiconductor diode of the pair.

16. The light source of claim 14 further comprising:
a second substrate frame;
wherein the first substrate frame connects to one semiconductor diode of each pair, and
the second substrate frame connects to the other semiconductor diode of each pair.

17. The light source of claim 15 wherein the plurality of conduits are positioned inside the first substrate frame in an alternating pattern of the cooling fluid inlets and the cooling fluid outlets, with at least one cooling fluid inlet being positioned closer to at least one pair of semiconductor diodes than any of the cooling fluid outlets.

19. A method of producing light comprising:
emitting light from a plurality of side emitting semiconductor diodes coupled to a substrate having a plurality of conduits where the light emitted is formed in a uniform pattern on a single focal plane;
cooling the plurality of side emitting semiconductor diodes by providing an aqueous fluid flowing through a plurality of conduits on the substrate;
focusing the uniform light pattern through a micro lens; and
generating a single collimated beam of light.

20. A light source comprising:
a first plurality of side-emitting diodes connected in a row on a first planar substrate, the first plurality of diodes being arranged so that a light from each diode is emitted in a common direction;
a second plurality of side-emitting diodes connected in a row on a second planar substrate, the second plurality of diodes being arranged so that a light from each diode is emitted in the common direction; and
a substrate for securing the first and second planar substrates in a parallel configuration and providing electrical input for the first and second plurality of diodes.

21. The light source of claim 20 wherein the first and second planar substrates are part of a wafer from which the first and second plurality of diodes were fabricated, respectively.
